(19) United States
(12) Patent Application Publication
(10) Pub. No.: US 2013/0052423 A1
(43) Pub. Date: Feb. 28, 2013

(54) PHOTOSENSITIVE COMPOSITION, METHOD FOR MANUFACTURING MOLDED ARTICLE, MOLDED ARTICLE AND SEMICONDUCTOR DEVICE

(71) Applicants: Yuuki SUEMITSU, Tokyo (JP); Naoyuki Kawashima, Tokyo (JP); Shuuichi Sugawara, Tokyo (JP)

(72) Inventors: Yuuki SUEMITSU, Tokyo (JP); Naoyuki Kawashima, Tokyo (JP); Shuuichi Sugawara, Tokyo (JP)

(73) Assignee: JSR Corporation, Tokyo (JP)

(21) Appl. No.: 13/591,224

(22) Filed: Aug. 22, 2012

(30) Foreign Application Priority Data
Aug. 23, 2011 (JP) 2011-181199
Apr. 26, 2012 (JP) 2012-100621
Jul. 18, 2012 (JP) 2012-159271

(51) Int. Cl. B29C 59/16; B32B 3/30; C08L 35/02

(52) U.S. Cl. 428/156; 522/79; 264/447

(57) ABSTRACT

A method for manufacturing a molded article includes applying a photosensitive composition to at least one of a first plate and a second plate to form a coated film. The first plate is pressed against the second plate with the coated film therebetween. The coated film of the photosensitive composition is exposed. The first plate is separated from the second plate. The exposed coated film is heated. At least one of the first plate and the second plate has a pattern including concave and convex on its surface, and the coated film conforms to the pattern in the step of pressing the first plate against the second plate. The photosensitive composition includes a thioether compound, a photopolymerization initiator other than a phosphine oxide compound and an α-aminoalkylphenone compound, and a compound having 1 to 6 (meth)acryloyl groups in one molecule.

### BACKGROUND OF THE INVENTION

1. Field of the Invention

The present invention relates to a photosensitive composition, to a method for manufacturing a molded article using this photosensitive composition, to a molded article obtained by this method for manufacturing a molded article, and to a semiconductor device provided with this molded article.

2. Description of the Related Art

An effective way of imparting heat resistance to a molded article obtained from a photosensitive composition is to add an antioxidant to the photosensitive composition.

However, the problem is that antioxidants with hindered phenol structures lower the UV curing properties of the photosensitive composition because of their strong radical capture ability. Adding a strongly curing radical initiator is known to increase the UV curing properties, but the problem is that strongly curing radical initiators have poor storage stability because their absorption range includes the visible light range. Another problem is yellowing and the like that occurs when the molded article is heated and makes it unsuitable for transparent material applications such as transparent films and camera lens modules.

On the other hand, sulfur-containing antioxidants present little hindrance to UV curing, but cause problems of solubility in (meth)acrylate compounds. Therefore, for example, a polymer having a terminal thio(meth)acrylate end group has been proposed as a means of improving solubility in (meth)acrylate compounds (Japanese Patent Application Publication No. 2010-209279). A curable resin composition, which contains this polymer, a (meth)acrylate compound and a radical polymerization initiator, has also been proposed (Japanese Patent Application Publication No. 2010-209279).

### SUMMARY OF THE INVENTION

It is an object of the present invention to provide a photosensitive composition having excellent storage stability and UV curing properties, and capable of forming a heat resistant molded article, as well as a method of manufacturing a molded article using the photosensitive composition, a molded article obtained by this method of manufacturing a molded article, and a semiconductor device provided with the molded article.

As a result of exhaustive research aimed at solving these problems, the inventors perfected the present invention after discovering that the object of the present invention could be achieved by means of a photosensitive composition containing a specific thioether compound, a specific photopolymerization initiator and a specific compound having a (meth)acryloyl group, and with a method of manufacturing a molded article using this photosensitive composition perfected the present invention after.

That is, the present invention provides [1] to [13] below.

[1] A method for manufacturing a molded article, comprising a step of applying a photosensitive composition to at least one of a first plate and a second plate to form a coated film of the photosensitive composition, a step of pressing the first plate against the second plate with the coated film of the photosensitive composition therebetween, a step of exposing the coated film of the photosensitive composition, with the first plate and second plate pressed together with the coated film of the photosensitive composition therebetween, a step of separating the first plate from the second plate, and a step of heating the exposed coated film of the photosensitive composition, at least one of the first plate and the second plate having a pattern including concave and convex on its surface, and the coated film of the photosensitive composition conforming to the pattern of the first plate and/or the second plate in the step of pressing the first plate against the second plate, wherein the photosensitive composition comprises: (a) a thioether compound represented by the following general formula (1):

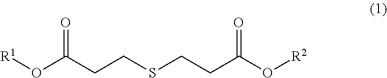

wherein R¹ and R² are each independently an organic group having 1 to 20 carbon atoms; (b) a photopolymerization initiator other than a phosphine oxide compound and an α-aminoalkylphenone compound; and (c) a compound having 1 to 6 (meth)acryloyl groups in one molecule.

[2] The method for manufacturing a molded article according to [1] above, wherein the component (a) is a thioether compound in which R¹ and R² in the general formula (1) each independently represent a hydrocarbon group having 12 to 18 carbon atoms and having optionally an alkoxy group or aryloxy group substituted for a hydrogen atom.

[3] The method for manufacturing a molded article according to [2] above, wherein the component (a) is ditridecyl thiodipropionate.

[4] The method for manufacturing a molded article according to any of [1] to [3] above, wherein the component (b) is a hydroxyketone compound having a group represented by the following general formula (2)

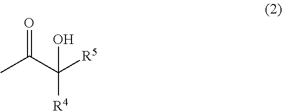

wherein each of R⁴ and R⁵ may independently be a hydrogen atom or an organic group having 1 to 20 carbon atoms, and R⁴ and R⁵ may form a single organic group having a cyclic structure having 3 to 20 carbon atoms.

[5] The method for manufacturing a molded article according to any of [1] to [4] above, wherein the component (c) comprises 10 to 99.89 mass parts (i.e. parts by mass or parts by weight) of an aromatic group-containing (meth)acrylate compound relative to the total of the component (a), the component (b) and the component (c) taken as 100 mass parts.

[6] The method for manufacturing a molded article according to any of [1] to [5] above, wherein the component (c) comprises 10 to 70 mass parts of a fluorene compound (c-1) represented by the following general formula (3) relative to the total of the component (a), the component (b) and the component (c) taken as 100 mass parts:

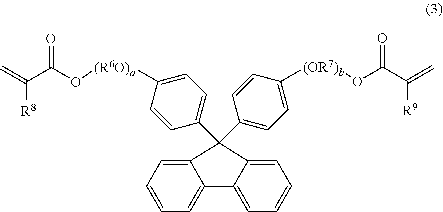

wherein each of R⁶ and R⁷ independently represents a linear or branched alkylene group having 2 to 4 carbon atoms, each of R⁸ and R⁹ independently represents a hydrogen atom or methyl group, a and b are integers, and a+b=0 to 24; and a fluorene framework in the general formula (3) may also have a substituent having 1 to 28 carbon atoms.

[7] The method for manufacturing a molded article according to any of [1] to [6] above, wherein the component (c) comprises 10 to 50 mass parts of a biphenyl compound (c-2) represented by the following general formula (4) relative to the total of the component (a), the component (b) and the component (c) taken as 100 mass parts:

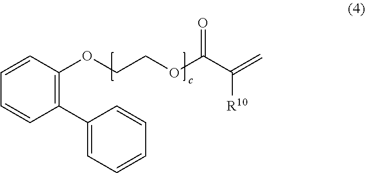

wherein R¹⁰ is a hydrogen atom or methyl group, c is an integer from 0 to 24, and a biphenyl framework in the general formula (4) may have a substituent having 1 to 28 carbon atoms.

[8] The method for manufacturing a molded article according to any of [1] to [7] above, wherein the content of the component (a) is 0.01 to 20 mass parts, the content of the component (b) is 0.1 to 20 mass parts, and the content of the component (c) is 60 to 99.89 mass parts relative to the total of the component (a), the component (b) and the component (c) taken as 100 mass parts.

[9] The method for manufacturing a molded article according to any of [1] to [8] above, wherein the molded article is a lens.

[10] A molded article obtained by the method for manufacturing a molded article according to any of [1] to [9] above.

[11] A molded article containing a thioether compound represented by the following general formula (1):

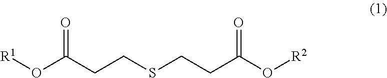

wherein R¹ and R² are each independently an organic group having 1 to 20 carbon atoms.

[12] A semiconductor device comprising the molded article according to [10] or [11] above.

[13] A photosensitive composition comprising: (a) a thioether compound represented by the following general formula (1):

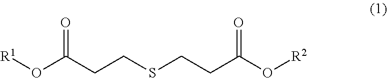

wherein R¹ and R² are each independently an organic group having 1 to 20 carbon atoms; (b) a photopolymerization initiator other than a phosphine oxide compound and an α-aminoalkylphenone compound; and (c) a compound having 1 to 6 (meth)acryloyl groups in one molecule.

The photosensitive composition of the present invention has excellent storage stability and UV curing properties. Moreover, because a molded article (i.e. a molded product) obtained by using the photosensitive composition of the present invention has excellent heat resistance, this molded article can be used as a material requiring heat resistance.

### BRIEF DESCRIPTION OF THE DRAWINGS

FIG. 1 is a flow chart showing the first part of the first embodiment of the method of manufacturing a molded article of the present invention;

FIG. 2 is a flow chart showing the second part of the first embodiment of the method of manufacturing a molded article of the present invention; and

FIG. 3 is a flow chart showing the second embodiment of the method of manufacturing a molded article of the present invention.

### DESCRIPTION OF THE PREFERRED EMBODIMENTS

1. Photosensitive Composition

The photosensitive composition of the present invention comprises a specific thioether compound (a), a photopolymerization initiator (b) (excluding a phosphine oxide compound and an α-aminoalkylphenone compound), and a compound having 1 to 6 (meth)acryloyl groups in the molecule, and may also contain an antioxidant (d) other than the specific thioether compound (a).

The photosensitive composition of the present invention is explained in detail below.

[Component (a)]

The component (a) in the photosensitive composition of the present invention is a thioether compound represented by the following general formula (1):

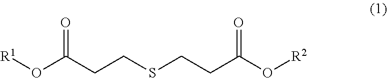

wherein R¹ and R² are each independently an organic group having 1 to 20 carbon atoms.

For purposes of improving solubility in (meth)acrylate compounds, each of R¹ and R² in the general formula (1) is preferably a hydrocarbon group having 12 to 18 carbon atoms, more preferably a hydrocarbon group having 12 to 14 carbon atoms, and most preferably a hydrocarbon group having 13 carbon atoms. These hydrocarbon groups may be either linear or branched.

Examples of the component (a) include ditridecyl thiodipropionate, dilauryl thiodipropionate, distearyl thiodipropionate, dimyristyl thiodipropionate, lauryl stearyl thiodipropionate and the like. Of these, ditridecyl thiodipropionate is preferred.

Commercial examples of the component (a) include DLTP, DSTP and DMTP (all manufactured by API Corporation), ADEKA Stab AO-4125 and AO-503 (all manufactured by Adeka Corp.) and the like.

Because the radical capture ability of the component (a) is low, there is no problem of reduced curing ability. Moreover, the component (a) has good solubility in (meth)acrylate compounds. The photosensitive composition of the present invention has excellent storage stability as a result, and a molded article obtained from the photosensitive composition of the present invention has excellent heat resistance without decrease of UV curing ability.

The content of the component (a) is preferably 0.01 to 20 mass parts, more preferably 0.05 to 5 mass parts, and most preferably 0.1 to 2.5 mass parts relative to the total of the component (a), the component (b) and the component (c) taken as 100 mass parts. If this amount is less than 0.01 mass parts, heat resistance may not be sufficiently improved. If this amount exceeds 30 mass parts, the curing properties may deteriorate.

[Component (b)]

The photosensitive composition of the present invention contains a photopolymerization initiator other than a phosphine oxide compound and an α-aminoalkylphenone compound as the component (b) in order to impart photosensitivity. However, phosphine oxide compounds and α-aminoalkylphenone compounds are excluded from the component (b) used in the present invention.

Examples of photopolymerization initiators include the photopolymerization initiators shown in the following (1) to (11), which have absorption at 365 nm for example.

(1) Benzophenone, 4,4′-bis(diethylamino)benzophenone, methyl o-benzoylbenzoate, 4-benzoyl-4′-methyldiphenyl ketone, dibenzyl ketone, fluorenone and other benzophenone derivatives.

(2) 2,2′-diethoxyacetophenone, 2-hydroxy-2-methylpropiophenone, 2,2-dimethoxy-1,2-diphenylethane-1-one, 1-hydroxy-cyclohexyl-phenyl-ketone (Irgacure 184 (product name) manufactured by BASF Corp.), 2-methyl-1-[4-(methylthio)phenyl]-2-morpholinopropane-1-one, 2-hydroxy-1-{4-[4-(2-hydroxy-2-methylpropionyl)-benzyl]-phenyl}-2-methylpropane-1-one (Irgacure 127, manufactured by BASF Corp.), methyl phenylglyoxylate and other acetophenone derivatives.

(3) Thioxanthone, 2-methylthioxanthone, 2-isopropyl thioxanthone, diethyl thioxanthone and other thioxanthone derivatives.

(4) Benzyl, benzyl dimethyl ketal, benzyl-β-methoxyethyl acetal, (2-hydroxy-1-{4-[4-(2-hydroxy-2-methylpropionyl)-benzyl]-phenyl}-2-methylpropane-1-one) (Irgacure 127, manufactured by BASF Corp.) and other benzyl derivatives.

(5) Benzoin, benzoin methyl ether, 2-hydroxy-2-methyl-1-phenylpropane-1-one and other benzoin derivatives.

(6) 1-phenyl-1,2-butanedione-2-(O-methoxycarbonyl)oxime, 1-phenyl-1,2-propanedione-2-(O-methoxycarbonyl)oxime, 1-phenyl-1,2-propanedione-2-(O-ethoxycarbonyl)oxime, 1-phenyl-1,2-propanedione-2-(O-benzoyl)oxime, 1,3-diphenylpropanetrione-2-(O-ethoxycarbonyl)oxime, 1-phenyl-3-ethoxypropanetrione-2-(O-benzoyl)oxime, 1,2-octanedione, 1-[4-(phenylthio)-2-(O-benzoyl oxime)] (OXE-01, manufactured by BASF Corp.), ethanone, 1-[9-ethyl-6-(2-methylbenzoyl)-9H-carbazole-3-yl]-, 1-(O-acetyloxime) (Irgacure OXE-02, manufactured by BASF Corp.) and other oxime compounds.

(7) 2-hydroxy-2-methyl-1-phenylpropane-1-one, 1-[4-(2-hydroxyethoxy)phenyl]-2-hydroxy-2-methyl-1-propane-1-one, 2-hydroxy-1-{4-[4-(2-hydroxy-2-methylpropionyl)-benzyl]phenyl}-2-methylpropane and other hydroxyketone compounds.

(8) Bis(η5-2,4-cyclopentadiene-1-yl)-bis(2,6-difluoro-3-(1H-pyrrole-1-yl)phenyl)titanium and other titanocene compounds.

(9) Ethyl-p-(N,N-dimethylaminobenzoate) and other benzoate derivatives.

(10) 9-phenylacridine and other acridine derivatives.

(11) 2-hydroxy-1-(4-isopropenylphenyl)-2-methylpropane-1-one oligomer (Irgacure 907, manufactured by BASF Corp.) and other polymeric photopolymerization initiators.

Of these, a hydroxyketone compound is preferred, because it produces little yellowing and no loss of transparency even when a photosensitive composition containing the photopolymerization initiator is heated.

Examples of hydroxyketone compounds include hydroxyketone compounds having groups represented by the following general formula (2):

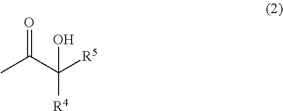

wherein each of R⁴ and R⁵ is a hydrogen atom or an organic group having 1 to 20 carbon atoms, and R⁴ and R⁵ together may form a single organic group having a cyclic structure having 3 to 20 carbon atoms.

Examples of hydroxyketone compounds having groups represented by the general formula (2) include compounds represented by the following general formula (2-1) or general formula (2-2):

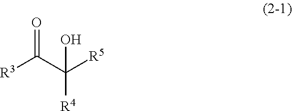

wherein R³ is an organic group having 1 to 20 carbon atoms, each of R⁴ and R⁵ is a hydrogen atom or an organic group having 1 to 20 carbon atoms, and R⁴ and R⁵ together may form a single organic group having a cyclic structure having 3 to 20 carbon atoms),

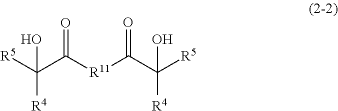

wherein R⁴ and R⁵ are the same as those in the general formula (2-1), and R¹¹ is a single bond, an organic group having 1 to 20 carbon atoms, or a group represented by the following general formula (2-3).

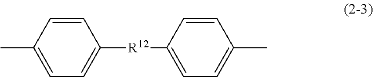

wherein R¹² is a single bond or an organic group having 1 to 20 carbon atoms.

In the general formula (2-1), R³ is an organic group having 1 to 20 carbon atoms. R³ is for example an aliphatic, aromatic or mixed aliphatic/aromatic univalent hydrocarbon group having 1 to 20 carbon atoms, which may be branched or unbranched, and may be saturated or unsaturated. Examples of R³ include alkyl groups, alkenyl groups, aryl groups and aralkyl groups. Of these, aryl groups and aralkyl groups are preferred.

In the general formula (2-2), R¹¹ is a single bond, an organic group having 1 to 20 carbon atoms, or a group represented by the general formula (2-3). R¹¹ is for example an aliphatic, aromatic or mixed aliphatic/aromatic bivalent hydrocarbon group having 1 to 20 carbon atoms, which may be branched or unbranched, and may be saturated or unsaturated. Examples of R¹¹ include alkylene groups, alkenylene groups, arylene groups and aralkylene groups.

In the general formula (2-3), R¹² is a single bond or an organic group having 1 to 20 carbon atoms. R¹² is for example an aliphatic bivalent hydrocarbon group having 1 to 20 carbon atoms, which may be branched or unbranched, and may be saturated or unsaturated. Examples of R¹² include alkylene groups and alkenylene groups.

Examples of hydroxyketone compounds having groups represented by the general formula (2) include 1-hydroxycyclohexyl phenyl ketone, 2-hydroxy-1-{4-[4-(2-hydroxy-2-methyl-propionyl)-benzyl]phenyl}-2-methyl-propane-1-one and 2-hydroxy-1-(4-isopropenylphenyl)-2-methylpropane-1-one oligomer, which have absorption at 365 nm.

Of these, 1-hydroxycyclohexyl phenyl ketone and 2-hydroxy-1-{4-[4-(2-hydroxy-2-methyl-propionyl)-benzyl]phenyl}-2-methyl-propane-1-one are preferred.

The chemical formula of 1-hydroxycyclohexyl phenyl ketone is as shown by the following formula (5). The chemical formula of 2-hydroxy-1-{4-[4-(2-hydroxy-2-methyl-propionyl)-benzyl]phenyl}-2-methyl-propane-1-one is as shown by the following formula (6).

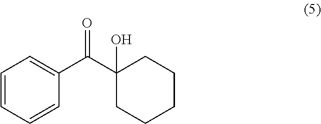 [SMILES: O=C(c1ccccc1)C1(O)CCCCC1]

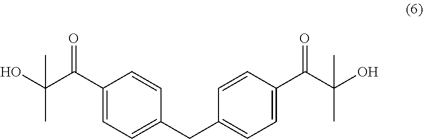 [SMILES: CC(C)(O)C(=O)c1ccc(Cc2ccc(C(=O)C(C)(C)O)cc2)cc1]

One kind of component (b) may be used, or two or more kinds may be used in combination.

When the total of the component (a), the component (b) and the component (c) in the present invention is 100 mass parts, the content of the component (b) is preferably 0.1 to 20 mass parts, more preferably 0.5 to 10 mass parts, and most preferably 1 to 5 mass parts. If this amount is less than 0.1 mass parts, the efficiency of the polymerization reaction may deteriorate. If this amount exceeds 20 mass parts, the properties of the hardened photosensitive composition may deteriorate.

[Component (c)]

Because the photosensitive composition of the present invention contains a compound (c) having 1 to 6 (meth)acryloyl groups in the molecule, it is polymerized and cured by the action of component (b) when being exposed.

Desirable examples of the component (c) include aromatic group-containing (meth)acrylate compounds.

Examples of the component (c) include phenoxyethyl(meth)acrylate, tribromophenolethoxy(meth)acrylate, (meth)acrylates of the alcohol which is ethylene oxide adduct of phenol, (meth)acrylates of the alcohol which is ethylene oxide adduct of p-cumylphenol, 4-(1-methyl-1-phenylethyl)phenoxyethyl(meth)acrylate, (meth)acrylates of the alcohol which is ethylene oxide adduct of nonylphenol, 2-methacryloyloxyethyl phthalic acid, 2-methacryloyloxypropyl hexahydrophthalic acid, 2,2-bis-(2-hydroxy-3-acryloxypropylphenyl)propane, bisphenol A-type ethylene oxide adduct di(meth)acrylate, tetrabromobisphenol A-type ethylene oxide adduct di(meth)acrylate, bisphenol A-type propylene oxide adduct di(meth)acrylate, tetrabromobisphenol A-type propylene oxide adduct di(meth)acrylate, bisphenol A-type epoxy di(meth)acrylate obtained from an epoxy ring-opening reaction of bisphenol A diglycidyl ether and (meth)acrylic acid, tetrabromobisphenol A-type epoxy di(meth)acrylate obtained from an epoxy ring-opening reaction of tetrabromobisphenol A diglycidyl ether and (meth)acrylic acid, bisphenol F-type epoxy di(meth)acrylate obtained from an epoxy ring-opening reaction of bisphenol F diglycidyl ether and (meth)acrylic acid, tetrabromobisphenol F-type epoxy di(meth)acrylate obtained from an epoxy ring-opening reaction of tetrabromobisphenol F diglycidyl ether and (meth)acrylic acid, 2,2,2-tris(meth)acryloyloxy methylethyl succinic acid, succinic acid-denatured pentaerythritol triacrylate and the like.

In the present invention, the content of an aromatic group-containing (meth)acrylate compound in the component (c) is preferably 10 to 99.89 mass parts, and more preferably 20 to 95.00 mass parts relative to the total of the component (a), the component (b) and the component (c) taken as 100 mass parts. If this amount is 10 mass parts or more, better heat resistance can be obtained. If this amount is 99.89 mass parts or less, the amount of the component (a) and the like may be sufficient, and better storage stability and the like can be obtained.

From the standpoint of solubility and refractive index, preferred examples of aromatic group-containing (meth)acrylate compounds include fluorene compounds (c-1) represented by the following general formula (3):

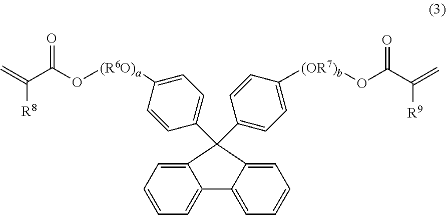

wherein each of R⁶ and R⁷ independently represents a linear or branched alkylene group having 2 to 4 carbon atoms, each of R⁸ and R⁹ independently represents a hydrogen atom or methyl group, a and b are integers, and a+b=0 to 24; and the fluorene framework in General Formula (3) may also have a substituent having 1 to 28 carbon atoms.

Examples of the component (c-1) include 9,9-bis[4-(2-acryloyloxyethoxy)phenyl]fluorene and the like.

In the present invention, the content of the component (c-1) in the component (c) is preferably 10 to 70 mass parts, and more preferably 20 to 50 mass parts relative to the total of the component (a), the component (b) and the component (c) taken as 100 mass parts from the standpoint of solubility and refractive index and the like.

From the standpoint of viscosity adjustment, preferred examples of aromatic group-containing (meth)acrylate compounds include biphenyl compounds (c-2) represented by the following general formula (4):

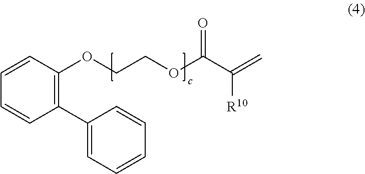

wherein R¹⁰ is a hydrogen atom or a methyl group, c is an integer from 0 to 24, and the biphenyl framework in the general formula (4) may have a substituent having 1 to 28 carbon atoms.

Examples of the compounds represented by the general formula (4) include ethoxylated o-phenylphenol acrylate, o-phenylphenol glycidyl ether(meth)acrylate, hydroxyethylated o-phenylphenol acrylate and the like.

In the present invention, the content of the component (c-2) in the component (c) is preferably 10 to 50 mass parts, and more preferably 20 to 40 mass parts relative to the total of the component (a), the component (b) and the component (c) taken as 100 mass parts from the standpoint of viscosity adjustment.

The following compounds are examples of the components (c) other than the component (c-1) and the component (c-2).

Examples of compounds having one (meth)acryloyl group in the molecule include isobornyl(meth)acrylate, dicyclopentenyl(meth)acrylate, dicyclopentanyl(meth)acrylate, 1-adamantyl(meth)acrylate, isodecyl(meth)acrylate, lauryl(meth)acrylate, dicyclopentenyl oxyethyl(meth)acrylate, methyl(meth)acrylate, ethyl(meth)acrylate, cyclohexyl(meth)acrylate, dicyclopentadienyl(meth)acrylate, tricyclodecanyl(meth)acrylate, diacetone acrylamide, isobutoxymethyl(meth)acrylamide, N-vinyl pyrrolidone, N-vinyl caprolactam, 3-hdyroxycyclohexyl(meth)acrylate, ω-carboxy-polycaprolactone monoacrylate, 2-acryloylcyclohexyl succinic acid, methoxypolyethylene glycol(meth)acrylate and the like.

Commercial examples of compounds having one (meth)acryloyl group in the molecule include New Frontier IBA (Daiichi Kogyo Seiyaku Co., Ltd.); IBXA, IBXMA and ADMA (Osaka Organic Chemical Industry Ltd.); FA511A, FA512A and FA513A (Hitachi Chemical); Light Ester M, E, BH, IB-X, HO-MS, HO-HH, L, PO, S and TD and Light Acrylate L-A, S-A, EC-A, MTG-A, 130A, PO-A, P-200A, NP-4EA, THF-A, IB-XA, HOA-MS, HOA-MPL and HOA-MPE (Kyoeisha Chemical Co., Ltd.); Aronix M150, M156, M5300, TO1315 and TO1316 (Toagosei Co., Ltd.); FA544A, 512M, 512MT and 513M (Hitachi Chemical); and NK ester A-CMP-1E, A-LEN-10, M-450G, S, S-1800M, S-1800A, PHE-1G, NPA-8E, NPA-5P, NPA-10G, M-90G, LMA, LA, 1B, CB-26, CB-23, CB-1, AMP-60G, AM-30G, A-SA, A-1B and 702A (Shin-Nakamura Chemical Co., Ltd.) and the like.

Examples of compounds having two (meth)acryloyl groups in the molecule include ethylene glycol di(meth)acrylate, tetraethylene glycol di(meth)acrylate, polyethylene glycol di(meth)acrylate, 1,4-butanediol di(meth)acrylate, 1,6-hexanediol di(meth)acrylate, 1,9-nonanediol di(meth)acrylate, neopentyl glycol di(meth)acrylate, tricyclodecane dimethanol di(meth)acrylate and the like.

Commercial examples of compounds having two (meth)acryloyl groups in the molecule include Viscoat #700 and #540 (Osaka Organic Chemical Industry Ltd.); Aronix M-208, M-210 and M-215 (Toagosei Co., Ltd.); NK ester A-DOD, A-NPG, DCP, A-DCP, BPE-100, BPE-200, BPE-500, A-BPE-4 and A-BPEF (Shin-Nakamura Chemical Co., Ltd.); Light Acrylate 1,6-HX-A, Light Ester BP-4EA and BP-4PA, and Epoxy Ester 3002M, 3002A, 3000M and 3000A (Kyoeisha Chemical Co., Ltd.); Kayarad R-551 and R-712 (Nippon Kayaku Co., Ltd.); BPE-4, BPE-10 and BR-42M (Daiichi Kogyo Seiyaku Co., Ltd.); Lipoxy VR-77, VR-60, VR-90, SP-1506, SP-1507, SP-1509 and SP-1563 (Showa Highpolymer); and Neopol V779 and Neopol V779MA (Nippon Yupika) and the like.

Examples of compounds having 3 to 6 (meth)acryloyl groups in the molecule include tris(2-hydroxyethyl)isocyanurate tri(meth)acrylate, caprolactone-denatured tris(2-hydroxyethyl)isocyanurate tri(meth)acrylate, trimethylolpropane tri(meth)acrylate, ethylene oxide (hereinafter abbreviated as “EO”)-denatured trimethylolpropane tri(meth)acrylate, propylene oxide (hereinafter abbreviated as “PO”)-denatured trimethylolpropane tri(meth)acrylate, ditrimethylolpropane tetra(meth)acrylate, pentaerythritol tri(meth)acrylate, 2,2,2-tris(meth)acryloyloxy methylethyl phthalic acid, EO-denatured tris(acryloxy)isocyanurate, caprolactone-denatured tris(2-acryloxyethyl)isocyanurate, tris(acryloxy)isocyanurate, pentaerythritol tetra(meth)acrylate, PO-denatured pentaerythritol tetra(meth)acrylate, dipentaerythritol hexa(meth)acrylate, dipentaerythritol penta(meth)acrylate, dipentaerythritol tetra(meth)acrylate, EO-denatured dipentaerythritol hexa(meth)acrylate, PO-denatured dipentaerythritol hexa(meth)acrylate, caprolactone-denatured dipentaerythritol hexa(meth)acrylate, caprolactone-denatured dipentaerythritol penta(meth)acrylate, ditrimethylolpropane tetra(meth)acrylate, triacryloyloxyethyl phosphate and the like.

Commercial examples of compounds having 3 to 6 (meth)acryloyl groups in the molecule include Aronix M-315, M-325, M-327, TO-756 and TO-1382 (Toagosei Co., Ltd.); NK Ester TM-4EL, CBX-O, CBX-1N, A-DPH-6H, A-9300, A-DPH, A-9300-1CL, TMPT, IMPT-9EO, ATM-4P, ATM-4E, ATM-35E, AD-TMP, A-TMPT, A-IMPT-3EO, A-IMPT-3PO, A-TMMT, and A-TMM-3LMN (Shin-Nakamura Chemical Co., Ltd.); Light Ester TMP and Light Acrylate TMP-A, TMP-6EO-3A, PE-3A, PE-4A, DPE-6A, BA-134 and IMP-3EO-A (Kyoeisha Chemical Co., Ltd.); Viscoat 295, 360, 3PA and 400 (Osaka Organic Chemical Industry Ltd.); and Kayarad PET-30 and DPHA (Nippon Kayaku Co., Ltd.) and the like.

A polyether acrylate oligomer, polyester acrylate oligomer or polyepoxy acrylate oligomer, which has polyether or polyester in the main chain, may also be used.

One kind of the compounds described above may be used singly as the component (c), or a combination of two or more kinds can be used.

The content of the component (c) in the present invention is preferably 60 to 99.89 mass parts, more preferably 70 to 99.00 mass parts, and most preferably 80 to 98.00 mass parts relative to the total of the component (a), the component (b) and the component (c) taken as 100 mass parts. If this amount is 60 mass parts or more, better curing properties and the like can be obtained. If this amout is 99.89 mass parts or less, the amount of the component (a) and the like may be sufficient, and better heat resistance can be obtained.

[Component (d)]

An antioxidant (i.e. component (d)) other than the specific thioether compound (i.e. component (a)) may also be included in the photosensitive composition of the present invention with the aim of controlling the UV curing properties.

Examples of the component (d) include hydrazides, hindered amine antioxidants, nitrogen-containing heterocyclic mercapto compounds, hindered phenol antioxidants, ascorbic acids, zinc sulfate, thiocyanic acid salts, thiourea derivatives, sugars, nitrites, sulfites, thiosulfates, hydroxylamine derivatives and the like.

Of these, hindered phenol antioxidants are preferred from the standpoint of controlling the UV curing properties of the photosensitive composition when an aromatic group-containing (meth)acrylate compound such as the component (c-1) or the component (c-2) is used as the component (c).

Examples of such hindered phenol antioxidants include 3,9-bis[2-[3-(3-tert-butyl-4-hydroxy-5-methylphenyl)propionyloxy]-1,1-dimethylethyl]-2,4,8,10-tetraoxaspiro[5.5]undecane, pentaerythritol tetrakis[3-(3,5-di-t-butyl-4-hydroxyphenyl)propionate], thiodiethylene bis[3,5-di-t-butyl-4-hydroxyphenyl)propionate], octadecyl-3-(3,5-di-t-butyl-4-hydroxyphenyl)propionate], N,N′-hexane-1,6-diylbis[3-(3,5-di-t-butyl-4-hydroxyphenyl)propionamide], 3,5-bis(1,1-dimethylethyl)-4-hydroxybenzene propanic acid isooctyl 2,4-dimethyl-6-(1-methylpentadecyl)phenol, diethyl[[3,5-bis(1,1-dimethylethyl)-4-hydroxyphenyl]methyl]phosphonate 3,3′,3″,5,5′,5″-hexa-t-butyl-a,a′,a″-(mesitylene-2,4,6-triyl)tri-p-cresol, calcium diethylbis[[[3,5-bis(1,1-dimethylethyl)-4-hydroxyphenyl]methyl]phosphonate], 4,6-bis(octylthiomethyl)-o-cresol ethylene bis(oxyethylene)bis[3-(5-t-butyl-4-hydroxy-m-tolyl)propionate], hexamethylene bis[3-(3,5-di-t-butyl-4-hydroxyphenyl)propionate], 1,3,5-tris(3,5-di-t-butyl-4-hydroxybenzyl)-1,3,5-triazine-2,4,6(1H,3H,5H)-trione, a reaction product of N-phenylbenzenamine and 2,4,4-triemthylpentene, 2,6-di-t-butyl-4-(4,6-bis(octylthio)-1,3,5-triazine-2-ylamino)phenol, bis(1,2,2,6,6-pentamethyl-4-piperidyl)[[3,5-bis(1,1-dimethylethyl)-4-hydroxyphenyl]methyl]butylmalonate, 1-[2-[3-(3,5-di-t-butyl-4-hydroxyphenyl)propionyloxy]ethyl]-4-[3-(3,5-di-t-butyl-4-hydroxyphenyl)propionyloxy]-2,2,6,6-tetramethylpiperidine-4-benzoyloxy-2,2,6,6-tetramethylpiperidine and the like.

Of these, a hindered phenol antioxidant having a large substituent (such as a tert-butyl group, 1-methylpentadecyl group or octylthiomethyl group) in an ortho position (at least one selected from the 2 position and the 6 position) of a phenolic hydroxyl group is preferred.

Examples of such a hindered phenol antioxidant having a large substituent include 2,2-thio[diethylbis-3(3,5-di-t-butyl-4-hydroxyphenyl)propionate], 3,9-bis[2-[3-(3-tert-butyl-4-hydroxy-5-methylphenyl)propionyloxy]-1,1-dimethylethyl]-2,4,8,10-tetraoxaspiro[5.5] undecane and the like.

The content of the component (d) is preferably 100 mass parts or less, more preferably 5 to 100 mass parts, and most preferably 10 to 50 mass parts relative to the content of the component (a) taken as 100 mass parts. If this amount exceeds 100 mass parts, the curing properties of the photosensitive composition may deteriorate.

[Other Additives]

The photosensitive composition of the present invention may also contain various additives such as a phosphine oxide photopolymerization initiator, α-aminoalkylphenone photopolymerization initiator, photosensitizer, mold release agent, solvent, light stabilizer, aging inhibitor, plasticizer, adhesion promoter, thermal polymerization initiator, colorant, inorganic particles, elastomer particles, fluidity adjuster, antifoaming agent, dispersant or the like to the extent that these do not detract from the object and characteristics of the present invention.

The aforementioned photosensitizer is normally used together with the component (b).

Examples of photosensitizers include triethylamine, diethylamine, N-methyl diethanolamine, ethanolamine, 4-dimethylaminobenzoic acid, methyl 4-dimethylaminobenzoate, ethyl 4-dimethylaminobenzoate, isoamyl 4-dimethylaminobenzoate and the like.

Commercial examples of photosensitizers include Ubecryl P102, 103, 104 and 105 (UCB Co., Ltd.) and the like.

Examples of the aforementioned phosphine oxide photopolymerization initiator include bis(2,4,6-trimethylbenzoyl)-phenylphosphine oxide, bis(2,6-dimethoxybenzoyl)-2,4,4-trimethyl-pentylphosphine oxide, 2,4,6-trimethylbenzoyl-diphenyl-phosphine oxide (Lucilin TPO, BASF Corp.) and the like.

Examples of the aforementioned α-aminoalkylphenone photopolymerization initiator include 2-benzyl-2-dimethylamino-1-(4-morpholinophenyl)-butanone-1 (Irgacure 369, BASF Corp.), 2-methyl-1-(4-methylthiophenyl)-2-morpholinopropane-1-one (Irgacure 907, BASF Corp.), 2-dimethylamino-2-(4-methylbenzyl)-1-(4-morpholine-4-yl-phenyl)butane-1-one and the like.

2. Method of Manufacturing Molded Article

The photosensitive composition of the present invention can yield a molded article (i.e. a shaped product) by being exposed.

One example of the method of manufacturing a molded article using the photosensitive composition of the present invention is a molded article manufacturing method including a step of applying the photosensitive composition of the present invention to at least one of a first plate and a second plate, a step of pressing the first plate against the second plate with the coated film of the photosensitive composition therebetween, a step of curing the coated film of the photosensitive composition by exposing the coated film, a step of separating the first plate from the second plate, and a step of heating the cured coated film of the photosensitive composition, wherein at least one of the first plate and the second plate has a pattern including concave and convex on its surface; the coated film of the photosensitive composition conforms to the surface having the aforementioned pattern in the step of pressing the first plate against the second plate; and a hardened article (i.e. a cured product) having the corresponding pattern to the aforementioned pattern is formed when the coated film is cured in the subsequent step (i.e. the step of curing the coated film by exposure).

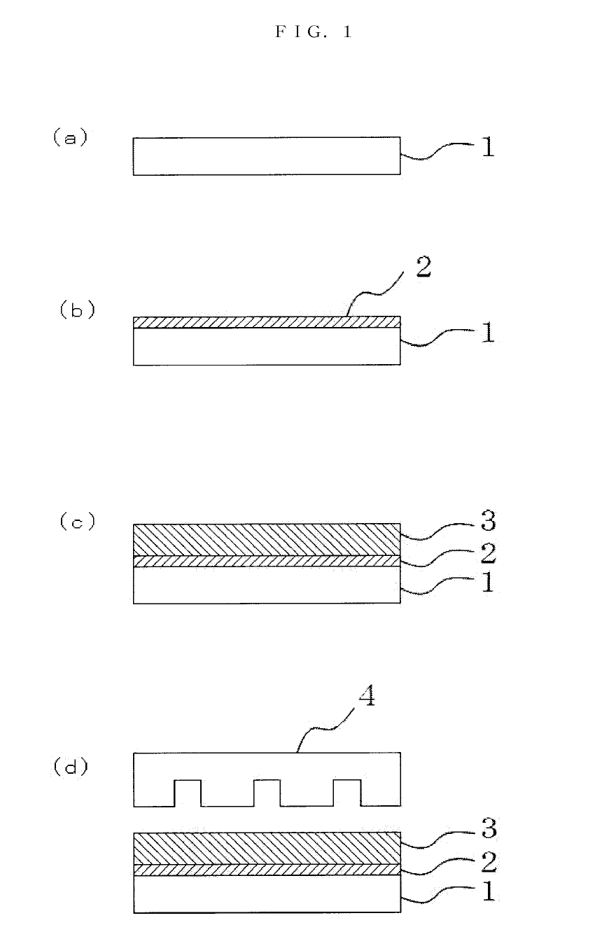

FIGS. 1 to 3 are flow charts illustrating embodiments of the method of manufacturing a molded article using the photosensitive composition of the present invention. The present invention is explained below with reference to the drawings.

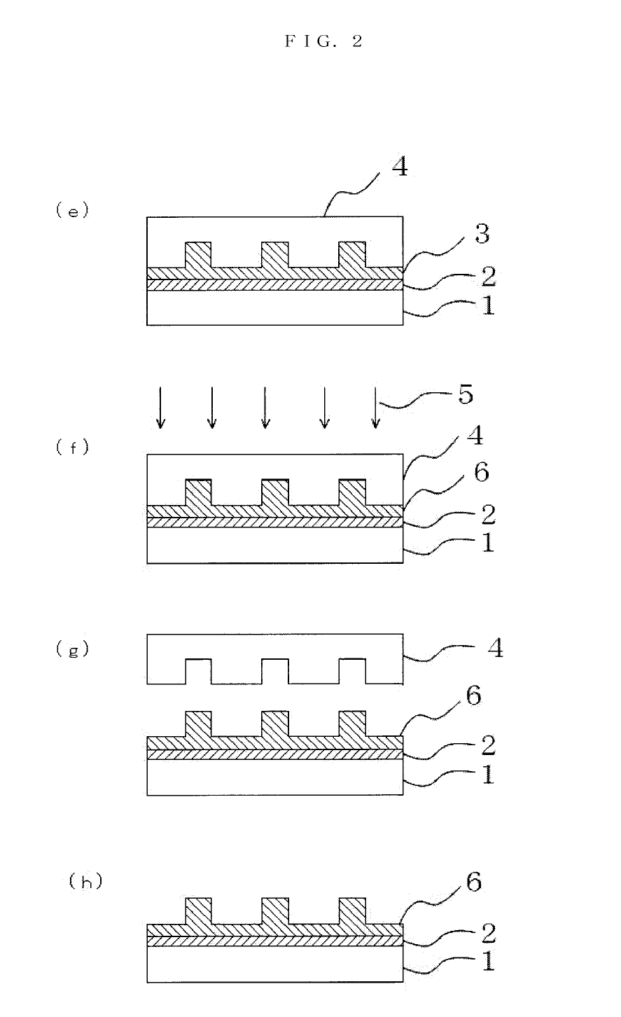

FIGS. 1 and 2 show the first embodiment of the method of manufacturing a molded article. FIG. 1 shows the first part (i.e. from (a) to (d) in FIG. 1) of the first embodiment, and FIG. 2 shows the second part (i.e. from (e) to (h) in FIG. 2) of the first embodiment.

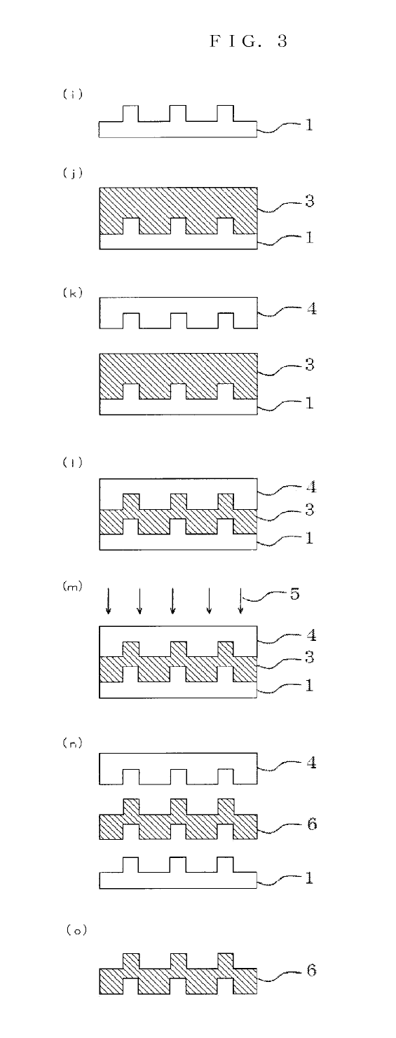

FIG. 3 shows the second embodiment of the method of manufacturing a molded article. The second embodiment includes (i) to (o) as shown in FIG. 3.

In FIGS. 1 to 3, reference numeral 1 indicates the first plate. Reference numeral 2 indicates a coated film of silane coupling agent. Reference numeral 3 indicates a coated film of the photosensitive composition. Reference numeral 4 indicates the second plate. Reference numeral 5 indicates light for exposure. Reference numeral 6 indicates a cured coated film of the photosensitive composition.

Reference letter (c) in FIG. 1 and reference letter (j) in FIG. 3 illustrate the step of applying the photosensitive composition of the present invention to at least one of a first plate 1 and a second plate 4 to form a coated film 3 of the photosensitive composition. At least one of the first plate 1 and the second plate 4 is formed of an article capable of transmitting light, such as transparent resin or the like. This transparent resin is not particularly limited, but may be highly transparent polydimethyl siloxane, cyclo olefin polymer or the like. The other plate may be formed of a silicon plate, glass plate or the like for example.

In FIG. 1 and FIG. 3, the second plate 4 has a pattern of concave and convex on its surface of the side facing the first plate 1. The first plate 1 may have a flat surface facing the second plate 4 (see (a) in FIG. 1), or a pattern including concave and convex on its surface of the side facing the second plate 4 (see (i) in FIG. 3). Normally, the photosensitive composition 3 is applied to a flat surface (see (c) in FIG. 1) or a surface having such a pattern described above (see (j) in FIG. 3).

In (a)-(c) in FIG. 1, silane coupling agent 2 is applied before the application of the photosensitive composition 3.

The term of “concave and convex” in this specification means “not flat” (i.e. “having a concave part and/or a convex part”). The concave parts and/or convex parts of “concave and convex” may have various shapes such as “point-like” (e.g. hemisphere-like), “linear” (e.g. linearly-formed cuboid), and the like.

The examples of “concave and convex” include a surface having concave parts and convex parts at random, a surface having only concave parts on a flat side, a surface having only convex parts on a flat side, a surface having concave parts and convex parts alternately on a flat side, and the like.

Examples of methods of applying the photosensitive composition of the present invention to at least one of the first plate and the second plate include spin coating, dipping, spraying, bar coating, roll coating, curtain coating, gravure printing, silk screening, ink jet printing and the like.

Reference letter (e) in FIG. 2 (hereinafter abbreviated as FIG. 2(e)) and reference letter (l) in FIG. 3 (hereinafter abbreviated as FIG. 3(l)) indicate the step of pressing the first plate 1 against the second plate 4 with the coated film 3 of the photosensitive composition therebetween.

In FIG. 2(e) and FIG. 3(l), the first plate 1 and the second plate 4 are pressed together in such a way that the coated film 3 of the photosensitive composition is sandwiched between the first plate 1 and the second plate 4, so that the coated film 3 of the photosensitive composition conforms to the pattern including the concave and convex on the surface of the first plate 1 and/or the second plate 4.

Reference letter (f) in FIG. 2 and reference letter (m) in FIG. 3 indicate the step of curing the coated film 3 of the photosensitive composition to obtain a cured coated film 6 by exposing the coated film 3 to light, with the first plate 1 and the second plate 4 pressed together with the coated film 3 of the photosensitive composition between the first plate 1 and the second plate 4.

Visible light, ultraviolet light, infrared light, X-rays, alpha rays, beta rays, gamma rays or the like can be used as the light used for exposure. Light having wavelengths of 200 to 450 nm is preferred from the standpoint of industrial versatility, and light having wavelengths that include a wavelength of 365 nm which is ultraviolet light is especially desirable.

Light exposure is preferably performed at an intensity of 1 to 1,000 mW/cm² and an irradiance level of 0.01 to 5,000 mJ/cm², preferably 0.1 to 1,000 mJ/cm².

The exposure light source may be one that uses a mirror, a lens or an optical fiber to produce convergent light from either a lamp light source capable of illuminating a wide area simultaneously such as a high-pressure mercury lamp, a low-pressure mercury lamp, a metal halide lamp, a excimer lamp or the like; a laser light source such as a pulse, a continuous emission, or the like; or the combination of a lamp light source capable of illuminating a wide area simultaneously and a laser light source.

Reference letter (g) in FIG. 2 and reference letter (n) in FIG. 3 indicate the step of separating the first plate 1 from the second plate 4.

In FIG. 2(g), the cured coated film 6 of the photosensitive composition remains adhering to the surface of the first plate 1 after the first plate 1 was separated from the second plate 4. In this way, the cured coated film 6 of the photosensitive composition is separated from the second plate 4, and a relief pattern of the cured film 6 of the photosensitive composition can be formed on the surface of the first plate 1.

In FIG. 3(n), the cured coated film 6 of the photosensitive composition is separated from both the first plate 1 and the second plate 4. As shown in FIG. 3, when both the first plate 1 and the second plate 4 have a pattern including concave and convex, the coated film 3 of the photosensitive composition conforms to the surface patterns of both the first plate 1 and the second plate 4 in the step of pressing the first plate 1 against the second plate 4 (see (l) in FIG. 3), resulting in a molded article (i.e. the cured coated film 6) having surface relief patterns on both surfaces.

The step of separating the first plate 1 from the second plate 4 is followed by a step of heating the cured film 6 of the photosensitive composition, either alone or together with the adhering plate. Curing of the cured parts can be promoted by heating following light exposure. The heating conditions differ according to the composition of the photosensitive composition and the types of additives and the like, but normally the heating temperature is preferably 30 to 300° C., and more preferably 50 to 200° C., and the heat time is preferably 10 seconds to 5 hours, and more preferably 30 seconds to 1 hour.

A step of coating a silane coupling agent 2 on either one of the first plate 1 and the second plate 4 can also be included before the step of applying the photosensitive composition of the present invention (see FIG. 1(b)). The adhesiveness between the photosensitive composition and the plate can be improved by coating a silane coupling agent 2. The photosensitive composition 3 is attached to the plate 1 with the coated layer of the silane coupling agent 2 therebetween (see FIG. 1(c)), and a relief pattern formed by the cured coated film 6 of the photosensitive composition is formed on the surface of the first plate 1 which is coated with the silane coupling agent 2.

Examples of silane coupling agents include trimethoxysilyl benzoic acid, γ-methacryloxypropyl trimethoxysilane, vinyl triacetoxysilane, vinyl trimethoxysilane, γ-isocyanatopropyl triethoxysilane, γ-glycidoxypropyl trimethoxysilane, β-(3,4-epoxycyclohexyl)ethyl trimethoxysilane and the like.

Methods similar to those used for coating the photosensitive composition on at least one of the first plate 1 and the second plate 4 can be used for coating the silane coupling agent 2.

3. Molded Article

A molded article obtained by the method for manufacturing a molded article of the present invention can be used as a transparent membrane, lens (i.e. camera lens module or the like), a cured relief pattern of a semiconductor device, or the like. Of these, it is especially suited to use as a molded article requiring particular heat resistance, such as a lens (i.e. camera lens module, etc.) or the like, because the molded article of the present invention is excellent in heat resistance.

The refractive index of the molded article of the present invention at 25° C. is preferably 1.60 or more. The Abbe number of the molded article is preferably less than 30.

It is a feature of the molded article of the present invention that it contains the thioether compound represented by the following general formula (1):

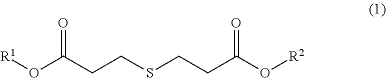

wherein R¹ and R² are each independently an organic group having 1 to 20 carbon atoms.

The specifics of this thioether compound are the same as for the component (a). The molded article of the present invention is excellent in heat resistance, because the molded article contains the aforementioned thioether compound. The presence of the thioether compound in the molded article can be confirmed by solid S³³ NMR, ion chromatography or X-ray fluorescence analysis.

4. Semiconductor Device

The semiconductor device of the present invention has the aforementioned molded article. Examples of semiconductor devices include portable phones having camera lenses, portable cameras, and other imaging elements.

### EXAMPLES

The present invention is explained in more detail below using Examples, but the present invention is not limited to these Examples.

### [Raw Materials Used]

The following raw material was used as an antioxidant corresponding to the component (a) of the present invention:

(1-1) Ditridecyl thiodipropionate (AO-503™, Adeka Corp.).

The following raw materials were used as other antioxidants:

(1-2) 2,2-thio[diethylbis-3(3,5-di-t-butyl-4-hydroxyphenyl)propionate] (Irganox™ 1035, BASF Corp.);

(1-3) 6-tert-butyl-4-[3-[(2,4,8,10-tetra-tert-butyldibenzo[d,f][1,3,2]dioxaphosphepin-6-yl)oxy]propyl]-2-methylphenol (Sumilizer™ GP, Sumitomo Chemical);

(1-4) Bis[3-(dodecylthio)propionic acid]2,2-bis[[3-(dodecylthio)-1-oxopropyloxy]methyl]-1,3-propanediyl (Seenox™ 412S, Shipro Kasei Kaisha, Ltd.).

With regard to the component (b) of the present invention, the following raw materials were used as photopolymerization initiators that were hydroxyketone compounds:

(2-1) 1-hydroxycyclohexylphenyl ketone (Irgacure™ 184, BASF Corp.);

(2-2) 2-hydroxy-1-{4-[4-(2-hydroxy-2-methyl-propionyl)-benzyl]phenyl}-2-methyl-propane-1-one (Irgacure™ 127, BASF Corp.);

(2-3) 2-hydroxy-1-(4-isopropenylphenyl)-2-methylpropane-1-one oligomer (KIP150™, Lamberti).

The following raw materials were used as other photopolymerization initiators:

(2-4) 2,4,6-trimethylbenzoyl-diphenyl-phosphine oxide (Lucirin TPO™, BASF Corp.);

(2-5) 2-methyl-1-(4-methylthiophenyl)-2-morpholinopropane-1-one (Irgacure™ 907, BASF Corp.).

The following raw materials were used as compounds having (meth)acryloyl groups which correspond to the component (c) of the present invention:

(3-1) 9,9-bis[4-(2-acryloyloxyethoxy)phenyl]fluorene (A-BPEF™, Shin-Nakamura Chemical Co., Ltd.);

(3-2) Ethoxylated o-phenylphenol acrylate (A-LEN-10™, Shin-Nakamura Chemical Co., Ltd.);

(3-3) Pentaerythritol triacrylate (A-TMM-3LM-N™, Shin-Nakamura Chemical Co., Ltd.);

(3-4) Bisphenol A, EO adduct acrylate (V#700™, (Osaka Organic Chemical Industry Ltd.).

### Example 1

32 mass parts of ethoxylated o-phenylphenol acrylate, 3 mass parts of pentaerythritol triacrylate and 30.5 mass parts of bisphenol A-type EO adduct acrylate were added to 31 mass parts of 9,9-bis[4-(2-acryloyloxyethoxy)phenyl]fluorene as the component (c).

3 mass parts of 1-hydroxycyclohexyl phenyl ketone were then added as the component (b), and 0.5 mass parts of ditridecyl thiopropionate were added as the component (a). A mixture of all of these compounds was heated to 60° C. while being agitated to dissolution with a web rotor and the like to obtain photosensitive composition (J-1). The composition is shown in Table 1.

### Examples 2 to 7, and Comparative Examples 1 to 6

Photosensitive compositions (J-2) to (J-13) were obtained in the same way as that in Example 1 except that compositions shown in Table 1 were used.

TABLE 1

| | | | J-1 | J-2 | J-3 | J-4 | J-5 | J-6 | J-7 | J-8 | J-9 | J-10 | J-11 | J-12 | J-13 |
|---|---|---|---|---|---|---|---|---|---|---|---|---|---|---|---|
| Antioxidant | Component(a) | 1-1 | 0.5 | 0.5 | 0.1 | 1.5 | 0.5 | 0.5 | 0.5 | 0.5 | 0.5 | | | | |
| | | 1-2 | | | | | 0.1 | | | | | | 0.5 | | |
| | | 1-3 | | | | | | | | | | | | 0.5 | |
| | | 1-4 | | | | | | | | | | | | | 0.5 |
| Photopolymerization | Component (b) | 2-1 | 3.0 | | 3.0 | 3.0 | 3.0 | | | | | 3.0 | 3.0 | 3.0 | 3.0 |
| initiator | | 2-2 | | 3.0 | | | | | 3.0 | | | | | | |
| | | 2-3 | | | | | | 3.0 | | | | | | | |
| | | 2-4 | | | | | | | 1.0 | 3.0 | | | | | |
| | | 2-5 | | | | | | | | | 3.0 | | | | |

| | | | | | | | | | | | | | | |
|---|---|---|---|---|---|---|---|---|---|---|---|---|---|---|
| Component (c) | 3-1 | 31.0 | 32.5 | 31.0 | 31.0 | 31.0 | 31.0 | 32.0 | 31.0 | 31.0 | 31.0 | 31.0 | 31.0 | 31.0 |
| | 3-2 | 32.0 | 32.0 | 32.0 | 32.0 | 32.0 | 32.0 | 32.0 | 32.0 | 32.0 | 32.0 | 32.0 | 32.0 | 32.0 |
| | 3-3 | 3.0 | 3.0 | 3.0 | 3.0 | 3.0 | 3.0 | 5.0 | 3.0 | 3.0 | 3.0 | 3.0 | 3.0 | 3.0 |
| | 3-4 | 30.5 | 29.0 | 30.9 | 29.5 | 30.4 | 30.5 | 26.5 | 30.5 | 30.5 | 31.0 | 30.5 | 30.5 | 30.5 |

| | | | | | | | | | | | | | |
|---|---|---|---|---|---|---|---|---|---|---|---|---|---|
| Total | 100.0 | 100.0 | 100.0 | 100.0 | 100.0 | 100.0 | 100.0 | 100.0 | 100.0 | 100.0 | 100.0 | 100.0 | 100.0 |

Unit: mass parts
1-1: Ditridecyl thiodipropionate
1-2: 2,2-thio[diethylbis-3(3,5-di-t-butyl-4-hydroxyphenyl)propionate]
1-3: 6-tert-butyl-4-[3-[(2,4,8,10-tetra-tert-butyldibenzo[d,f][1,3,2]dioxaphosphepin-6-yl)oxy]propyl]-2-methylphenol
1-4: Bis[3-(dodecylthio)propionic acid]2,2-bis[[3-(dodecylthio)-1-oxopropyloxy]methyl]-1,3-propanediyl
2-1: 1-hydroxycyclohexylphenyl ketone
2-2: 2-hydroxy-1-[4-[4-(2-hydroxy-2-methyl-propionyl)-benzyl]phenyl]-2-methyl-propane-1-one
2-3: Oligomer of 2-hydroxy-1-(4-isopropenylphenyl)-2-methylpropane-1-one
2-4: 2,4,6-trimethylbenzoyl-diphenyl-phosphine oxide
2-5: 2-methyl-1-(4-methylthiophenyl)-2-morpholinopropane-1-one
3-1: 9,9-bis[4-(2-acryloyloxyethoxy)phenyl]fluorene
3-2: Ethoxylated o-phenylphenol acrylate
3-3: Pentaerythritol triacrylate
3-4: EO adduct acrylate of bisphenol A

The physical properties of the resulting photosensitive compositions (J-1) to (J-13) were evaluated as follows. The results are shown in Table 2.

### (1) Viscosity Measurement

The viscosity of the photosensitive composition was measured with a viscometer (Viscometer TV-10, Toki Sangyo Co., Ltd.) at 25° C. A viscosity of 4,000 mPa·s or less is preferred.

### (2) Evaluation of UV Curing Properties

One drop of the photosensitive composition was dripped with a dropper onto a borosilicate glass wafer, a PDMS molder was mounted from the top, and the composition was exposed to light (11 mW/cm², 365 nm) with a mask aligner (MA100CC, manufactured by Karl Suss). The PDMS molder was removed, and the lens surface was touched with a finger to check for tackiness. Tackiness was checked again at different irradiance levels, and the minimum irradiance level at which no tackiness was detected was evaluated. The minimum irradiance level is preferably 2.0 J or less.

(3) Evaluation of Repeated Curing Properties with PDMS Molder

In the same way as that in the evaluation method of UV curing properties, lens molding was performed 30 times using a PDMS molder, and the resulting lens surfaces were observed by optical microscopy. The number of times that the PDMS molder was used before damage was observed on the lens surface was evaluated. The number of times of use is preferably 30 or more.

### (4) Measurement of Refractive Index and Abbe Number

The photosensitive composition was coated on a PET release film, an 0.5 mm-thick spacer was disposed around it, a borosilicate glass wafer was laid over the top, and the composition was exposed to light (11 mW/cm², 365 nm) for 2 minutes with a mask aligner (MA100CC, manufactured by Karl Suss). The PET release film and glass wafer were removed from the resulting 500 μm-thick cured film. This cured film was then annealed for 1 hour in a 150° C. oven (STPH-101, Espec Corp.). Using a multi-wavelength Abbe refractometer (DR-M2, manufactured by Atago), the refractive index was then measured at wavelengths of 486 nm (F rays), 589 nm (D rays) and 656 nm (C rays), and the Abbe number of the cured film was determined by the formula ν_{D}=(n_{D}−1)/(n_{F}−n_{C}) from the refractive indexes at the three wavelengths.

The refractive index at 589 nm is preferably 1.60 or more, and the Abbe number is preferably 30 or less.

### (5) Measurement of Initial Transmittance

The photosensitive composition was coated on a PET release film, an 0.5 mm-thick spacer was disposed around it, a borosilicate glass wafer was laid over the top, and the composition was exposed to light (11 mW/cm², 365 nm) for 2 minutes with a mask aligner (MA100CC, Karl Suss). The PET release film and glass wafer were removed from the resulting 500 μm-thick cured film. This cured film was then annealed for 1 hour in a 150° C. oven (STPH-101, manufactured by Espec Corp.). Transmittance was then measured at a wavelength of 400 nm using a spectrophotometer (Ubest V-570, manufactured by Jasco). The transmittance is preferably 95% or more.

### (6) Evaluation of Heat Resistance

A 500 μm-thick cured film was obtained in the same way as that described above from the photosensitive composition. The PET release film was removed from the resulting cured film, and was then annealed for 1 hour in a 150° C. oven (STPH-101, Espec Corp.). The cured film was then reflow-treated three times for 10 minutes per time in a 260° C. oven (STPH-101, Espec Corp.). The transmittance was then measured at a wavelength of 400 nm using a spectrophotometer (Ubest V-570, Jasco). The transmittance after heat resistance testing is preferably 95% or more.

### (7) Evaluation of Storage Stability

The photosensitive composition was left standing still in a chamber maintained at 23° C., and the presence or absence of foreign matter, precipitates and the like in the liquid was verified visually after 60 days. The viscosity at 25° C. was also measured with a viscometer (Viscometer TV-10, Toki Sangyo Co., Ltd.), and changes in viscosity after still standing were evaluated. A rating of “good” was given when there was no precipitation and no change in viscosity. A rating of “bad” was given when there was precipitation or change in viscosity.

TABLE 2

| | Example 1 | Example 2 | Example 3 | Example 4 | Example 5 | Example 6 | Example 7 |
|---|---|---|---|---|---|---|---|
| Photosensitive composition | J-1 | J-2 | J-3 | J-4 | J-5 | J-6 | J-7 |
| Viscosity (mPa · s) | 3600 | 3900 | 3600 | 3500 | 3600 | 3600 | 3900 |
| UV curing property | 1J | 1J | 1J | 1J | 2J | 2J | 1J |
| Repeated curing property with PDMS molder | >30 | >30 | >30 | >30 | >30 | >30 | >30 |
| (Number of times of use) | | | | | | | |
| Refractive index at 589 nm | 1.600 | 1.602 | 1.602 | 1.600 | 1.601 | 1.602 | 1.603 |
| Abbe number | 29 | 29 | 29 | 29 | 29 | 29 | 29 |
| Initial transmittance | 97 | 96 | 97 | 96 | 97 | 96 | 96 |
| (%) | | | | | | | |
| Transmittance after heat resistance testing | 96 | 95 | 96 | 95 | 96 | 95 | 95 |
| (%) | | | | | | | |
| Storage stability | Good | Good | Good | Good | Good | Good | Good |

| | Comparative | Comparative | Comparative | Comparative | Comparative | Comparative |
|---|---|---|---|---|---|---|
| | Example 5 | Example 6 | Example 1 | Example 2 | Example 3 | Example 4 |
| Photosensitive composition | J-8 | J-9 | J-10 | J-11 | J-12 | J-13 |
| Viscosity (mPa · s) | 3700 | 3600 | 3600 | 3700 | 3600 | 3700 |
| UV curing property | 1J | 1J | 1J | 3J | 3J | 1J |
| Repeated curing property with PDMS | >30 | >30 | >30 | >30 | >30 | >30 |
| molder (Number of times of use) | | | | | | |
| Refractive index at 589 nm | 1.601 | 1.600 | 1.602 | 1.600 | 1.600 | 1.601 |
| Abbe number | 29 | 29 | 29 | 29 | 29 | 29 |
| Initial transmittance | 11 | 84 | 94 | 97 | 95 | 96 |
| (%) | | | | | | |
| Transmittance after heat resistance | 86 | 57 | 80 | 95 | 93 | 95 |
| testing (%) | | | | | | |
| Storage stability | Good | Good | Good | Good | Good | Bad |
| | | | | | | (Unevenness) |

What is claimed is:

1. A method for manufacturing a molded article, comprising the steps of:
applying a photosensitive composition to at least one of a first plate and a second plate to form a coated film of the photosensitive composition;
pressing the first plate against the second plate with the coated film of the photosensitive composition therebetween;
exposing the coated film of the photosensitive composition, with the first plate and second plate pressed together with the coated film of the photosensitive composition therebetween;
separating the first plate from the second plate; and
heating the exposed coated film of the photosensitive composition, at least one of the first plate and the second plate having a pattern including concave and convex on its surface, and the coated film of the photosensitive composition conforming to the pattern of concave and convex in the step of pressing the first plate against the second plate,
wherein the photosensitive composition comprises:
(a) a thioether compound represented by the following general formula (1): 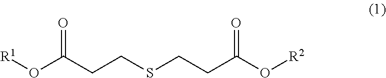
wherein R¹ and R² are each independently an organic group having 1 to 20 carbon atoms;
(b) a photopolymerization initiator other than a phosphine oxide compound and an α-aminoalkylphenone compound; and
(c) a compound having 1 to 6 (meth)acryloyl groups in one molecule.

2. The method for manufacturing a molded article according to claim 1, wherein the component (a) is a thioether compound in which R¹ and R² in the general formula (1) each independently represent a hydrocarbon group having 1 to 20 carbon atoms and having optionally an alkoxy group or an aryloxy group substituted for a hydrogen atom in the hydrocarbon group.

3. The method for manufacturing a molded article according to claim 2, wherein the component (a) is ditridecyl thiodipropionate.

4. The method for manufacturing a molded article according to claim 1, wherein the component (b) is a hydroxyketone compound having a group represented by the following general formula (2): 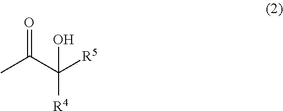
wherein R⁴ and R⁵ each independently is a hydrogen atom or an organic group having 1 to 20 carbon atoms, and R⁴ and R⁵ may form a single organic group having a cyclic structure having 3 to 20 carbon atoms.

5. The method for manufacturing a molded article according to claim 1, wherein the component (c) comprises 10 to 99.89 mass parts of an aromatic group-containing (meth)acrylate compound, relative to the total of the component (a), the component (b) and the component (c) taken as 100 mass parts.

6. The method for manufacturing a molded article according to claim 1, wherein the component (c) comprises 10 to 70 mass parts of a fluorene compound (c-1) represented by the following general formula (3), relative to the total of the component (a), the component (b) and the component (c) taken as 100 mass parts: 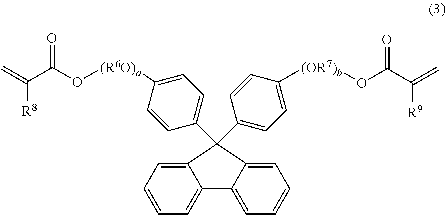
wherein R⁶ and R⁷ each independently represent a linear or branched alkylene group having 2 to 4 carbon atoms, R⁸ and R⁹ each independently represent a hydrogen atom or methyl group, a and b are integers, a+b=0 to 24, and a fluorene framework in the general formula (3) may have a substituent having 1 to 28 carbon atoms.

7. The method for manufacturing a molded article according to claim 1, wherein the component (c) comprises 10 to 50 mass parts of a biphenyl compound (c-2) represented by the following formula (4), relative to the total of the component (a), the component (b) and the component (c) taken as 100 mass parts: 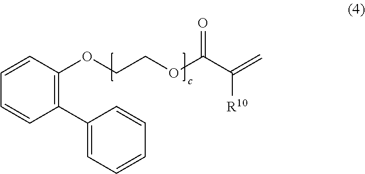
wherein R¹⁰ is a hydrogen atom or a methyl group, c is an integer from 0 to 24, and a biphenyl framework in the general formula (4) may have a substituent having 1 to 28 carbon atoms.

8. The method for manufacturing a molded article according to claim 1, wherein the content of the component (a) is 0.01 to 20 mass parts, the content of the component (b) is 0.1 to 20 mass parts, and the content of the component (c) is 60 to 99.89 mass parts, relative to the total of the component (a), the component (b) and the component (c) taken as 100 mass parts.

9. The method for manufacturing a molded article according to claim 1, wherein the molded article is a lens.

10. A molded article obtained by the manufacturing method according to claim 1.

11. A molded article containing a thioether compound represented by the following general formula (1): 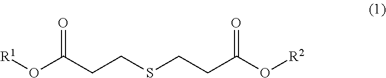
wherein R² and R² are each independently an organic group having 1 to 20 carbon atoms.

12. A semiconductor device comprising the molded article according to claim 10.

13. A photosensitive composition comprising:
(a) a thioether compound represented by the following general formula (1): 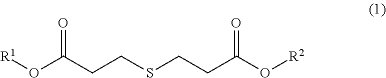
wherein R¹ and R² are each independently an organic group having 1 to 20 carbon atoms;
(b) a photopolymerization initiator other than a phosphine oxide compound and an α-aminoalkylphenone compound; and
(c) a compound having 1 to 6 (meth)acryloyl groups in one molecule.
